(19) United States
(12) Patent Application Publication
(10) Pub. No.: US 2026/0348888 A1
(43) Pub. Date: Nov. 5, 2026

(54) Method Using X-Ray Fluorescence Analysis for Determining an Amount of at Least One Printing Primer Applied to at Least One Paper Ply as Carrier Material

(71) Applicant: SWISS KRONO Tec AG, Luzern (CH)

(72) Inventors: Sabrina Pfeiffer, Kyritz (DE); Norbert Kalwa, Horn-Bad Meinberg (DE)

(21) Appl. No.: 19/487,573

(22) PCT Filed: May 27, 2024
(86) PCT No.: PCT/EP2024/064514

§ 371 Date: Nov. 25, 2025

(30) Foreign Application Priority Data
May 31, 2023 (EP) 23176405.1

(51) Int. Cl. G01N 23/223; B41F 19/00; B41F 23/04

(52) U.S. Cl. CPC G01N 23/223; B41F 19/001; B41F 23/04; G01N 2223/076; G01N 2223/1016; G01N 2223/303; G01N 2223/61

(57) ABSTRACT

A method for determining an amount of at least one print base coat applied to at least one paper layer as carrier material using X-ray fluorescence analysis is provided.

### CROSS-REFERENCE TO RELATED APPLICATIONS

This application is the United States national phase of International Patent Application No. PCT/EP2024/064514 filed May 27, 2024, and claims priority to European Patent Application No. 23176405.1 filed May 31, 2023, the disclosures of each of which are hereby incorporated by reference in their entireties.

### BACKGROUND

### Technical Field

The present disclosure relates to a method for determining the amount of at least one primer (print base coat) applied to at least one carrier material using X-ray fluorescence analysis.

### Technical Considerations

Substrates provided with a decoration, such as wood-based panels or paper layers, are mainly printed by gravure printing or digital printing.

The gravure printing process is a printing technique in which the elements to be depicted are present as indentations in a printing form that is inked before printing. The ink is primarily located in the indentations and is transferred to the object to be printed, such as a substrate, due to the contact pressure of the printing form and adhesion forces.

In digital printing, on the other hand, the printed image is transferred directly from a computer to a printing machine such as a laser printer or inkjet printer. This eliminates the use of a static printing form.

Digital printing is increasingly being used as part of the technical development of printing technology for a wide range of substrates. While digital printing processes were initially used primarily in the graphic arts industry, such as advertising agencies, advertising material manufacturers or print shops, it is now apparent that digital printing processes are also being used more frequently in other branches of industry. Although there are many reasons for this, two main arguments can be identified. Digital printing enables the production of a print image with a particularly high quality thanks to a higher resolution and also allows a wider range of applications with a high degree of flexibility. This is illustrated by the fact that there is no longer a limit to the length of the printed image.

It is important in all processes for printing on a medium (in this case paper, otherwise also wood-based panels) that a uniform and repeatable print image is created for the customer; both the colors and the shapes must match the master sample for each print. Deviations are not desired and will not be accepted

In order to print a paper with a digital printing ink, it is therefore necessary to apply an intermediate layer to the paper beforehand. A primer or print base coat is used as an intermediate layer to keep color deviations between the printed decors of a production batch or even between identical printed decors of different production batches as low as possible from the outset due to pigments that are knocked out. “Primer” and “print case coat” are used interchangeably herein.

The primer or print base coat has two functions: firstly, it forms a kind of barrier layer between the ink and the paper, and secondly, this primer or print base coat has a reactive component that reacts with the ink and thus ensures that an ink drop, which should have a certain size, no longer changes this size on the paper. The primer or print base coat reacts with the ink in such a way that a drop stops immediately and does not spread.

In addition, the use of a primer or print base coat reduces the amount of ink that has to be used for a print. Without a primer or print base coat, the ink sinks deep into the paper and a larger amount of ink must be used to achieve the desired print result. As the primer or print base coat is considerably cheaper than printing ink, its use results in significant cost savings.

The paper to be printed is coated with a primer or print base coat in the digital printing system. This is applied to a rubber roller and then to the paper using a roller (anilox roller; a curtain or spraying of the primer would also be possible) with a defined application volume. The primer or print base coat is then dried before the digital printing ink is applied and the paper is dried again.

This can result in various disadvantages.

The application of the primer or print base coat can be uneven due to various influences. This occurs, for example, in the event of (mechanical) damage to the anilox roller, (mechanical) damage to the rubber roller for transferring the primer or print base coat, skewed installation of one of the rollers, wear of the rollers, wear and tear and thus changes to the cup depth and thus the scoop volume, insufficient cleaning of the rollers and thus changes to the cup depth and thus the scoop volume. Wrinkling of the paper can also be responsible for different application volumes.

High costs are incurred due to unusable waste, repetition of production (material, personnel), complaints, and/or excessive use of materials (ink, primer or print base coat).

Production times increase due to repetition of production and/or costly roller changes because simple cleaning is no longer sufficient.

Furthermore, resources are wasted in the use of materials and personnel due to duplicate productions and rejects and/or due to excessive quantities of ink and primer.

### SUMMARY

The present disclosure is therefore based on the technical object of establishing a measuring method with which the primer application or print base coat application can be monitored both over time, i.e., the linear meters, and over the web width. By monitoring the primer or print base coat application, it can be ensured that there are no deviations in the printed image.

This object is solved by a method as described herein.

Accordingly, in some non-limiting embodiments, a method is provided for determining an amount of at least one primer or print base coat applied to at least one paper layer using X-ray fluorescence analysis, the method comprising the following steps:
providing a plurality of reference samples by applying at least one primer or print base coat comprising at least one divalent cation in respectively different quantitatively defined amounts to the at least one carrier material;
recording at least one X-ray fluorescence spectrum of each of the reference samples comprising the primer or print base coat comprising at least one divalent cation by using at least one X-ray fluorescence measuring head,
assigning the different quantitatively defined amounts of primer or print base coat of the reference samples to the respective recorded X-ray fluorescence spectra of said reference samples; and
creating a calibration model for the relationship between the recorded X-ray fluorescence spectra of the reference samples and the associated quantitatively defined amounts of primer or print base coat;
providing at least one sample to be measured by applying at least one layer of at least one primer or print base coat comprising the at least one divalent cation onto the at least one carrier material,
recording at least one X-ray fluorescence spectrum of the at least one sample to be measured using the at least one X-ray fluorescence measuring head,
determining the quantitative amount of the primer or print base coat applied to the carrier material in the at least one sample to be measured by comparing the X-ray fluorescence spectrum of the at least one sample to be measured with the calibration model created from the reference samples.

With the X-ray fluorescence analysis used in the present method, it is possible to reliably determine even small application quantities of the print base coat or primer.

X-ray fluorescence analysis (XRF) or X-ray fluorescence spectroscopy (XRF) is a method used in material analysis and is one of the most frequently used methods for the qualitative and quantitative determination of the elemental composition of a sample, as the samples are not destroyed by the measurement and no decomposition are required. X-ray fluorescence analysis (XRF) is used particularly widely in the metalworking industry, in the analysis of glass, ceramics and building materials as well as in the analysis of lubricants and mineral oil products.

The great advantage of X-ray fluorescence over other measuring methods is that even the smallest application quantities (<1 g/m²) can still be reliably determined. This is the case when applying the primer or print base coat.

By irradiating the material sample with X-rays, the electrons of the element to be determined are first knocked out of the inner orbits of the electron shell. Subsequently, electrons from the outer shells fall back into these gaps and emit characteristic X-rays. This is specific for each element and allows the element quantity to be determined. The element-specific X-rays are detected by a suitable radiation detector.

The element-specific X-rays emitted are displayed in the form of pulses or counts. The strength or amount of the emitted counts is proportional to the amount of primer or print base coat applied. The counts detected by the detector correspond to the quantity of photons released after irradiation of the reference sample or the at least one sample with high-energy radiation.

The present method enables a continuous non-contact online determination of the amount of primer or print base coat applied. This means that the amount of print base coat or primer quantity applied can be measured during ongoing production, both over the material web width and over the material web length. This is the only way to detect deviations that could lead to printing problems at an early stage.

Before the measurement technology can be used in the system, a calibration is first carried out using reference samples, whereby an uncoated substrate (such as untreated raw paper) is measured as a zero point and a calibration series is created with different amounts of primer or print base coat applied to the substrate. Different known quantities of primer or print base coat are applied to the substrate and analyzed by XRF. Based on the data obtained, an equalization line is created, on the basis of which the primer or print base coat quantity of the samples to be measured can be determined.

In some non-limiting embodiments, a primer or print base coat with different amounts of divalent cation(s), such as Ca²⁺, is applied as reference samples for the purpose of calibration, the overall spectrum is recorded and the emitted radiation is analyzed in the range specific to the divalent cation(s). The amount of reference sample applied is of 0.5 to 10 g/m², preferably of 1.0 to 8.0 g/m², more preferably of 2.0 to 6.0 g/m² of print base coat, e.g., 1.1 g/m²; 2.2 g/m²; or 3.3 g/m². The following correlation can be recognized: 24,000-26,000 counts for the zero sample; 120,000-130,000 counts for an amount of 1.1 g/m², 220,000-230,000 counts for an amount of 2.2 g/m², 310,000-320,000 counts for an amount of 3.3 g/m².

In some non-limiting embodiments, it is also possible to examine the emitted radiation for other elements.

In some non-limiting embodiments, for the samples to be measured in a production plant, an X-ray fluorescence measuring head is installed downstream of the primer or print base coat application unit and, if necessary, downstream of a subsequent dryer. The measured or detected X-rays can provide information about the concentration of the primer or print base coat in the sample to be measured. Ideally, the measured value should be constant. If there are deviations, this means that the actual primer or print base coat application quantities do not correspond to the target and that this can lead to deviations in the print image.

In some non-limiting embodiments, the measuring head can traverse across the material web during measurement or, alternatively, several measuring heads can be installed next to each other across the material web width so that the primer or print base coat application can be monitored across the material web width.

What all versions have in common is that the spectra are recorded continuously in order to observe the primer or print base coat application over the entire time. This allows deviations to be detected and rectified at an early stage.

This method can be used to ensure that the current actual print image corresponds to the stored master pattern, i.e., the target print image. This ensures that the customer's requirements are met.

Cost savings are achieved by detecting wear on the rollers in good time and replacing them, avoiding faulty production, optimizing the use of primer or print base coat and/or ink and/or saving time by avoiding faulty production and/or avoiding long downtimes due to defects on the application rollers. The optimal use of primer or print base coat and/or ink and/or the avoidance of faulty or duplicate productions also saves resources.

In some non-limiting embodiments, as already mentioned, the primer or print base coat used here (as a basis for digital printing) comprises at least one divalent cation, for example Mg²⁺, Ca²⁺, Sr²⁺, and/or Ba²⁺, preferably Ca²⁺. X-ray fluorescence analysis is efficient for elements with higher atomic numbers, such as Ca²⁺, Sr²⁺ or Ba²⁺. The divalent cation(s) thus serves as an indicator for the primer or print base coat quantity applied.

In some non-limiting embodiments, the divalent cations are present in the print base coat in the form of salts, for example in the form of chlorides, sulphates and/or formates. Suitable salts comprise calcium diformate, calcium chloride, barium sulphate, and/or calcium sulphate, whereby calcium chloride and calcium diformate are preferred.

The use of calcium carbonate, on the other hand, is not desirable because calcium carbonate has poor solubility in water.

In some non-limiting embodiments, the salts are preferably used in water-based dispersions that are completely miscible with water or partially soluble in water. Depending on the paper and printing requirements, these dispersions are diluted before being applied to the paper layer.

In some non-limiting embodiments, in addition to the bivalent salt, the dispersions used as primers or print base coats also comprise small amounts of organic solvents such as methanol and/or ethane-1,2-diol (glycol). The primer dispersion or print base coat dispersion should have a low solvent content of less than 10 wt %, preferably less than 5 wt %, more preferably less than 3 wt %, even more preferably less than 2 wt %, or less than 1 wt %. Typical solvents are ethane-1,2-diol (glycol) and/or methanol.

In some non-limiting embodiments, the concentration of the divalent cation salts in the primer dispersion or print base coat dispersion, or primer dispersion or print base coat dispersion (before dilution), can be of 5 to 25% by weight, or preferably of 10 to 20% by weight. For example, primer dispersion or print base coat dispersion mixtures with of 5 to 10% by weight calcium diformate and of 5 to 10% by weight methanol or with of 10 to 20% by weight calcium chloride and 0.1-1% by weight methanol may be used. The remainder is water.

In some non-limiting embodiments, before dilution, the solids content of the primer dispersion or print base coat dispersion is of 5 to 25% by weight, preferably of 10 to 20% by weight, more preferably of 13 to −18% by weight, or most preferably of 14 to 16% by weight. The viscosity of the undiluted dispersion is of 400 to 600 mPas, preferably of 450 to 550 mPas (at a shear rate of 1000 s⁻¹ at 25 °C).

As mentioned, the print base coat dispersions or primer dispersions are applied to the paper layer in diluted form. Water is the preferred diluent.

In some non-limiting embodiments, the viscosity of the primer dispersion or print base coat dispersion to be applied to the paper layer is adjusted by dilution to values of 30 to 100 mPas, preferably of 40 to 80 mPas, or more preferably of 50 to 70 mPas (measured in the 4 mm outlet cup 22-25 s at 23-26 °C.).

In some non-limiting embodiments, the solids content of the diluted primer dispersion or print base coat dispersion is of 1 to 15% by weight, preferably of 5 to 12% by weight, more preferably of 8 to 10% by weight, or most preferably 10% by weight.

In some non-limiting embodiments, the amount of (diluted) primer or print base coat applied to the minimum one carrier material is preferably of 0.5 g/m² to 10 g/m², preferably of 1 g/m² to 8 g/m², more preferably of 2 g/m² to 6 g/m², or most preferably of 4 to 6 g/m².

In some non-limiting embodiments, further components of the print base coat or primer mixture can comprise polymeric binders, such as from the group consisting of hydroxyethyl cellulose; hydroxypropyl cellulose; hydroxyethyl methyl cellulose; hydroxypropyl methyl cellulose; hydroxybutyl methyl cellulose; methyl cellulose; sodium carboxymethyl cellulose; sodium carboxymethyl hydroxethyl cellulose; water-soluble ethyl hydroxyethyl cellulose; cellulose sulphate; polyvinyl alcohol; vinyl alcohol copolymers; polyvinyl acetate; polyvinyl acetal; polyvinyl pyrrolidone; polyacrylamide; acrylamide/acrylic acid copolymer; polystyrene, styrene copolymers; acrylic and/or methacrylic polymers; styrene/acrylic copolymers; ethylene-vinyl acetate copolymer; vinylmethyl methyl vinyl acetate copolymer; vinyl methyl ether/maleic acid copolymer; poly(2-acrylamido-2-methylpropanesulfonic acid); poly(diethylenetriamine-coadipic acid) acid); polyvinylpyridine; polyvinylimidazole; polyethyleneimine modified with epichlorohydrin; polyethyleneimine ethoxylated; ether-bond containing polymers such as polyethylene oxide (PEO), polypropylene oxide (PPO), polyethylene glycol (PEG) and polyethylene glycol (PEG) and/or polyvinyl ether (PVE); polyurethane; melamine resins; gelatin; carrageenan; and/or dextran. A preferred polymer for the print base coat or primer is a polyvinyl alcohol (PVA), a vinyl alcohol copolymer or modified polyvinyl alcohol. The modified polyvinyl alcohol can be a cationic polyvinyl alcohol.

In some non-limiting embodiments, however, the print base coat or primer mixture used herein does not comprise any polymeric components that would, for example, cause an increase in viscosity. For example, in some non-limiting embodiments, the print base coat or primer does not comprise: Dextrins, starch, cellulose derivatives, polyurethanes, polyamides, polycarbodiimide.

In some non-limiting embodiments, the primer mixture may comprise other additives, such as dyes (e.g., TiO₂ as a white pigment), surfactants, biocides, antistatic agents, elastomers, UV absorbers, plasticizers, light stabilizers, pH adjusters, antistatic agents, bleaching agents, matting agents and/or the like. Thus, 2-methyl-2H-isothiazol-3-one and/or 5-chloro-2-methyl-2H-isothiazol-3-one can be added as further components of primer or print base coat mixtures, which, however, are preferably comprised in only small amounts of less than 0.005% by weight.

As explained above, an X-ray fluorescence spectrum is recorded from each sample to be measured. In some non-limiting embodiments, preferably, an overall spectrum is recorded so that, in addition to the selected divalent cation, other elements of the primer composition can also be determined. For example, it may be desirable to determine higher-value salts or oxides such as TiO₂ in addition to the divalent cation salt.

For this purpose, the sample to be measured is first excited (e.g., by electron impact) and the X-rays emitted by the excited element are determined. In the present method, the emitted X-rays can have an energy in a range of 2000 to 6000 eV, preferably in a range of 3000 to 550 eV, or even more preferably in a range of 3000 to 5000 eV.

In the case of determining the amount of Ca²⁺ as an indicator of the amount of print base coat or primer application, an energy range of 3600 to 3800 eV, preferably of 3620 to 3770 eV, is analyzed. In some non-limiting embodiments, the energy range for Ca²⁺ is an initial energy of 3627 eV and a final energy of 3763 eV. In the case of TiO₂, for example, an energy range of 4200 to 4700 eV would be analyzed.

In some non-limiting embodiments of the present method, the at least one primer or print base coat is applied to the at least one carrier material as a (diluted) liquid suspension or solution with a solids content of 1 to 15 wt %, preferably of 5 to 12 wt %, more preferably of 8 to 10 wt %, or most preferably at 10 wt %. The primer can be applied with an anilox roller or by spraying.

In some non-limiting embodiments of the present method, the primer application is dried and then the X-ray fluorescence spectrum is recorded using the at least one X-ray fluorescence measuring head.

A paper layer is used as the carrier material, for example a paper layer comprising at least one raw paper or at least one pre-treated impregnated paper.

If a paper layer is used, the paper used should have a smoothed surface so that the primer or print base coat applied to the paper layer does not penetrate the paper or is absorbed.

In some non-limiting embodiments, the at least one substrate to be printed on is at least one raw paper. Raw paper are papers that have not been subjected to sizing in the mass or impregnation of the surface with a resin or glue. Raw papers essentially consist of pulp, pigments and fillers and the usual additives. Softwood pulps, hardwood pulps or mixtures of both types of pulp can be used to produce raw papers such as decor papers. Inorganic color pigments such as metal oxides, metal hydroxides, metal oxide hydrates, metal sulfides, metal sulfates, metal chromates and/or metal molybdates as well as organic color pigments and/or dyes such as carbonyl colorants, cyanine colorants and/or others can be used to color the raw paper.

In some non-limiting embodiments, the raw paper to be printed is at least one paper web without impregnation.

In some non-limiting embodiments, the at least one substrate to be printed is at least one pre-treated, impregnated paper. By a pre-treated paper (or cellulose layer) is meant a paper or paper web impregnated with a resin solution. The paper can be impregnated with various resin solutions, for example melamine resins and/or urea resins, plastic-acrylate compounds or starch sizing. Mixtures of resins may also be present. It is also possible to impregnate the paper using resin powder. The use of resin powder is described in detail below.

In some non-limiting embodiments, an impregnated paper is used, which is provided with the following process steps (see also EP 2 980 313 A1): a) complete impregnation of the cellulose layer with a curable resin, e.g. formaldehyde resin), b) removing the excess resin forming on the surface (e.g., by stripping or squeegeeing), c) drying the impregnated cellulose layer in such a way that, after the water has evaporated from the resin, the cellulose fibers are at least partially exposed on the surface from which the resin was removed.

The resin remaining on the surface of the cellulose layer is sealed to the fiber tips by stripping or squeegeeing. During the drying process, the resin retracts into the fibers so that the fibers are impregnated with the resin but not enclosed by it. Such a surface is suitable for printing with aqueous digital printing inks.

The special device used for stripping or squeegeeing works in a similar way to a filling machine in which one or more rollers run backwards on the paper and absorb the excess resin. By varying the speed of the rollers, the quantity can be precisely controlled and repeatability ensured.

The paper weights can vary over a range of 30 to 250 g/m². For example, the paper weight of decorative papers can be of 30 to 150 g/m², preferably of 50 to 120 g/m², or more preferably of 80 to 100 g/m². In the case of raw paper or kraft paper, the paper weight can be of 50 to 250 g/m², preferably of 100 to 200 g/m², or more preferably of 120 to 150 g/m².

As mentioned, it is also possible to provide a wood-based panel as a carrier material to be coated with a primer. In this case, the wood-based panel can be a chipboard, medium density fiberboard (MDF), high density fiberboard (HDF), oriented strand board (OSB) or plywood, a wood-plastic mixture or a composite material, or a wood plastic composites (WPC) panel.

The present method is carried out continuously and online in a production line comprising at least one X-ray fluorescence measuring head and at least one control system. Two or three X-ray fluorescence measuring heads can also be provided at different points in the production line. Such a production line can be a production line for processing and/or finishing paper layers.

In some non-limiting embodiments, the production line comprises
at least one application unit for applying the primer or print base coat to the at least one carrier material, preferably a paper layer,
Optionally, at least one X-ray fluorescence measuring head provided downstream of the application unit;
at least one dryer arranged downstream of the applicator,
at least one X-ray fluorescence measuring head provided downstream of the dryer;
at least one printing device for printing on the base coated carrier material,
further application units, each with corresponding dryers for applying and drying at least one, preferably several, layers of resin to the printed substrate.

In some non-limiting embodiments, the production line comprises
at least one application unit with anilox roller for applying the primer or print base coat to the at least one substrate, preferably a paper layer,
Optionally, at least one X-ray fluorescence measuring head provided downstream of the application unit;
at least one dryer arranged downstream of the applicator,
at least one X-ray fluorescence measuring head provided downstream of the dryer;
at least one digital printer for printing on the base coated substrate,
further application units, each with corresponding dryers for applying and drying at least one, preferably several, resin layers on the printed substrate.

The production line is preferably run or operated at a line speed of of 100 to 200 m/min, preferably of 120 to 180 m/min, or more preferably of 130 to 150 m/min, e.g., 135 m/min.

In some non-limiting embodiments, it is intended to use more than one X-ray fluorescence measuring head, preferably two or three X-ray fluorescence measuring heads.

During the measurement, the X-ray fluorescence measuring head moves the sample to be measured, for example the paper layer provided with the primer, at 1.0 to 5.0 m/min, preferably 1.5-3.5 m/min, or more preferably 1.5-2.5 m/min, such as at 2.0 m/min.

As already mentioned, the carrier material is provided with a decor after application of the print base coat in digital printing. In digital printing, the printed image is transferred directly from a computer to a printing machine, such as a laser printer or inkjet printer. This eliminates the need to use a static printing form. Decorative printing is carried out using the inkjet principle in a single-pass process in which the entire width of the top side to be printed is covered, with the primed or print base coated carrier material being moved under the printer. However, it is also possible for the substrate to be printed on to be stopped under the printer, which then passes over the surface at least once during printing.

The printing inks are combined in separate print head rows in the digital printer, whereby one or two rows of print heads can be provided for each color. The colors of the digital printing inks are, for example, black, blue, red, reddish yellow, greenish yellow; CMYK can also be used as an option. The digital printing inks are optionally based on the same pigments that are used for analog and/or digital printing with water-based inks. The digital printing inks are preferably based on UV inks. However, it is also possible to use water-based digital printing inks or so-called hybrid inks. After printing, the decor print is dried and/or irradiated.

The printing inks are applied in a quantity of 0.5 to 30 g/m², preferably of 3 to 20 g/m², or more preferably of 3 to 15 g/m², e.g., of 0.5 g/m² to 13 g/m².

At least one, preferably several, resin layers are then applied to the printed decoration as protective or wear layers. The type and number of these layers are known to the skilled person.

The control system of the production line comprises at least one computerized evaluation unit (or processor unit) and a database. In the evaluation unit, the X-ray fluorescence spectrum measured for the primer-coated or print base-coated carrier material is compared with the calibration model created. The data determined in this way is stored in the database.

The data determined using this spectroscopic method can be used to control the production line. As described above, the non-contact measured parameter values of the X-ray fluorescence measuring head can be used directly and in “real time” for the control or regulation of the relevant system, for example by storing the actual values measured and stored in the database, e.g., a relational database, and comparing them with the target values of these parameters available there. The resulting differences are then used to control or regulate the production line.

In some non-limiting embodiments, the application unit for the print base coat and the subsequent dryer are controlled. If the values determined by the X-ray fluorescence measuring head and in the evaluation unit reveal a fault in the application, process steps can be specifically influenced or defects rectified.

For example, the contact pressure of the application roller of the application unit can be specifically controlled in order to compensate for irregularities in the surface of the carrier material. Incorrect application can also be caused by damage to the application roller; the application roller can be replaced and/or repaired accordingly. Another cause of faulty application can also be an empty container for the print base coat or a defective dryer. These faults can be rectified quickly and easily using the method described here.

A computer-implemented method and a computer program comprising instructions which, when the program is executed by a computer, cause the computer to execute the computer-implemented method, are provided for adjusting and controlling the production line. The computer program is stored in a memory unit of the control system of the production line.

### BRIEF DESCRIPTION OF THE DRAWING

The present disclosure is explained in more detail below with reference to the non-limiting and exemplary embodiment and FIGURE in the drawing.

FIG. 1 is an X-ray fluorescence spectrum of a carrier material coated with a print base coat and a carrier material without a primer or print base coat in accordance with the principles of the present disclosure

### DETAILED DESCRIPTION

### Calibration

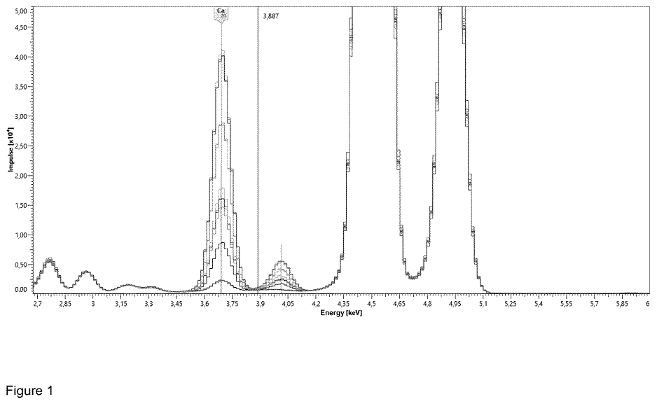

The diagram in FIG. 1 shows a typical X-ray fluorescence spectrum of a primer or print base coat layer applied to a raw paper layer. The primer used as a print base coat comprises Ca²⁺ in the form of calcium formate.

The samples were irradiated with beams in an energy range from 2 keV to 5.6 eV and the X-rays emitted were determined as pulses or counts.

An X-ray fluorescence measuring head from Spektro. was used to record the X-ray fluorescence spectra. The measuring head is a silicon drift or silicon PIN detector. The detector is selected specifically for the application. During the measurement, a short distance between the measuring head and the sample to be measured must be ensured. Preferably, this distance should only be a few millimeters.

Various primer quantities (0 g/m²; 1.1 g/m²; 2.2 g/m²; 3.3 g/m²) were applied and measured for calibration. Three measurements were carried out for each primer quantity at three different measuring points on the primer-coated raw paper layer: A-side (AS), B-side (BS), and center (middle). The reverse side (back) was also measured as a control.

The various measurements are shown as peaks in the X-ray fluorescence spectrum in FIG. 1. The typical signal for the Ca²⁺ cation lies in a range of 3.6 to 3.8 keV. It can be clearly seen that a primer-coated paper has significantly higher pulses than an uncoated paper. For example, the peaks for the sample coated with 3.3 g/m² primer reach maximum values of 4,000 pulses (on the x-axis), while the zero samples are at 700 pulses.

The integrals of the peaks are given as counts. Table 1 shows the individual values and mean values of the counts from the three respective measurements for each primer quantity.

TABLE 1
Correlation of primer (print base coat) quantity and counts of the
detected X-ray fluorescence beams. The mean values are used to
create a compensation line, on the basis of which the primer (print
base coat) quantity of the samples to be measured can be determined.

| Primer | | | |
|---|---|---|---|
| quantity (g/m²) | Sample designation | Counts | Counts (mean value) |
| 0 | Blind sample 2 Front | 25542 | 25149 |
| 0 | Blind sample 1 front | 24756 | |
| 0 | Blind sample 2 back | 24567 | 24557 |
| 0 | Blind sample 1 back | 24547 | |
| 1,1 | Pass 1 AS | 128501 | 124831 |
| 1,1 | Pass 1 BS | 127764 | |
| 1,1 | Pass 1 center | 118229 | |
| 1,1 | Pass 1 BS Back | 72191 | |
| 2,2 | Pass 2 AS | 223821 | 224624 |
| 2,2 | Pass 2 BS | 224051 | |
| 2,2 | Pass 2 center | 226000 | |
| 3,3 | Pass 3 AS | 306453 | 310012 |
| 3,3 | Flow 3 BS | 314678 | |
| 3,3 | Pass 3 center | 308906 | |
| 3,3 | Pass 3 AS Back | 140647 | |

### Example 1

In a paper digital printing system, untreated raw paper was coated with a primer (print base coat) in a first step to create a bond between the paper and the ink. The primer (print base coat) was applied to the paper using an anilox roller and then dried immediately. Behind the dryer was a traversing X-ray fluorescence measuring head that determined the amount of primer (print base coat). The measuring head traveled the entire web width of max. 2080 mm (corresponds to the width of a paper web) at approx. 2 m/min. After maintenance on the primer (print base coat) application unit, the system was run for a test. After one minute, a warning tone sounded and a signal light flashed. The system operators stopped the system manually. The measured values showed that the primer (print base coat) application on the left-hand side was well below the target. The primer (print base coat) application unit was then checked again. It turns out that there were differences in the contact pressure between the sides. Once the problem was rectified, the system continued to run without any problems.

### Example 2

In a digital paper printing system, the first step was to apply a primer (print base coat) to raw paper in order to create a bond between the paper and the ink. The primer (print base coat) was applied to the paper using an anilox roller and then dried immediately. Behind the dryer there were 3 X-ray fluorescence measuring heads evenly distributed across the width of the web, which determine the amount of primer. During the production application of a decor, the system stopped and a signal (acoustic and visual) appeared. The reason for this was a faulty application of the primer on the right-hand side. The X-ray fluorescence measuring head detected a 30% lower primer application rate at this point than on the left-hand side and in the middle. Inspection of the application unit showed that damage was visible on the right-hand side of the primer (print base coat) roller. The squeegee had damaged the cells and therefore the application quantity had been reduced.

### Example 3

In a digital paper printing system, the first step was to apply a primer to raw paper in order to create a bond between the paper and the ink. The primer was applied to the paper using an anilox roller and then dried immediately. Behind the dryer was a permanently installed X-ray fluorescence measuring head. During a large order of over 15 tons, a signal (acoustic/visual) was emitted by the system. The system stopped automatically. The X-ray fluorescence measuring head detected a primer (print base coat) application of 0 g/m². The system operators then determined that the primer IBC was empty and that no new container has been connected.

1. A method for determining an amount of at least one print base coat applied to at least one paper layer as a carrier material using X-ray fluorescence analysis comprising:
providing a plurality of reference samples by applying at least one print base coat comprising at least one divalent cation in respectively different quantitatively defined amounts to the at least one carrier material;
recording at least one X-ray fluorescence spectrum of each of the reference samples comprising the at least one print base coat comprising at least one divalent cation by using at least one X-ray fluorescence measuring head,
assigning the different quantitatively defined amounts of the at least one print base coat of the reference samples to the respective recorded X-ray fluorescence spectra of said reference samples;
creating a calibration model for the relationship between the recorded X-ray fluorescence spectra of the reference samples and the corresponding quantitatively defined amounts of the at least one print base coat;
providing at least one sample to be measured by applying at least one layer of at least one print base coat comprising the at least one divalent cation onto the at least one carrier material,
recording at least one X-ray fluorescence spectrum of the at least one sample to be measured using the at least one X-ray fluorescence measuring head, and
determining the quantitative amount of the at least one print base coat applied to the carrier material in the at least one sample to be measured by comparing the X-ray fluorescence spectrum of the at least one sample to be measured with the calibration model created from the reference samples.

2. The method according to claim 1, wherein the at least one print base coat comprises at least one salt with a divalent cation.

3. The method according to claim 1, wherein the at least one print base coat is applied to the at least one carrier material as a liquid suspension or solution with a solids content of 1 to 15% by weight.

4. The method according to claim 1, wherein the at least one print base coat is dried and then the X-ray fluorescence spectrum is recorded using the X-ray fluorescence measuring head.

5. The method according to claim 1, wherein the amount of the at least one print base coat applied to the at least one carrier material is more than 0.5 g/m².

6. The method according to claim 1, wherein the at least one carrier material comprises at least one raw paper or at least one pre-treated, impregnated paper.

7. The method according to claim 1, wherein the determination of the amount of the at least one print base coat applied is carried out continuously and online.

8. The method according to claim 2, wherein the at least one print base coat comprises at least one of Mg²⁺, Ca²⁺, Sr²⁺, or Ba²⁺.

9. The method according to claim 3, wherein the at least one print base coat is applied to the at least one carrier material as a liquid suspension or solution with a solids content of 5 to 12% by weight.

10. The method according to claim 5, wherein the amount of the at least one print base coat applied to the at least one carrier material is more than 1 g/m².

11. The method according to claim 1, wherein the amount of the at least one print base coat applied as reference sample(s) for the purpose of calibration is 0.5 to 10 g/m².

12. The method according to claim 1, wherein the at least one print base coat further comprises at least one organic solvent.

13. The method according to claim 1, wherein the at least one print base coat further comprises at least one polymeric binder.

14. The method according to claim 1, wherein the amount of (diluted) at least one print base coat applied to the at least one carrier material is 0.5 g/m² to 10 g/m².

15. A production line for carrying out the method according to claim 1, comprising
at least one application unit for applying the at least one print base coat to the at least one carrier material,
optionally, at least one X-ray fluorescence measuring head provided downstream of the application unit;
at least one dryer arranged downstream of an applicator of the application unit,
at least one X-ray fluorescence measuring head provided downstream of the dryer;
at least one printing device for printing on the base coated carrier material to form a printed substrate, and
further application unit(s), each with corresponding dryer(s) for applying and drying at least one layer of resin on the printed substrate.

16. The production line according to claim 15, further comprising a controller for controlling the application unit based at least upon the comparison of the fluorescence spectrum of at least one sample with the calibration model created from the reference samples.

17. A production line for carrying out the method according to claim 1, comprising
at least one application unit comprising an anilox roller for applying the at least one print base coat to the at least one carrier material,
optionally, at least one X-ray fluorescence measuring head provided downstream of the application unit;
at least one dryer arranged downstream of the applicator of the application unit,
at least one X-ray fluorescence measuring head provided downstream of the dryer;
at least one digital printer for printing on the base coated carrier material to form a printed substrate, and
further application unit(s), each with corresponding dryer(s) for applying and drying at least one layer of resin on the printed substrate.

18. The production line according to claim 17, further comprising a controller for controlling the production line based at least upon the comparison of the fluorescence spectrum of the at least one sample with the calibration model created from the reference samples.

19. A method for controlling a production line comprising:
providing a plurality of reference samples by applying at least print base coat comprising at least one divalent cation in respectively different quantitatively defined amounts to the at least one carrier material in a production line;
recording at least one X-ray fluorescence spectrum of each of the reference samples comprising the at least one print base coat comprising at least one divalent cation using at least one X-ray fluorescence measuring head,
assigning the different quantitatively defined amounts of the at least one print base coat of the reference samples to the respective recorded X-ray fluorescence spectra of said reference samples;
creating a calibration model for the relationship between the recorded X-ray fluorescence spectra of the reference samples and the corresponding quantitatively defined amounts of the at least one print base coat;
providing at least one sample to be measured by applying at least one layer of at least one print base coat comprising the at least one divalent cation to the at least one carrier material,
recording at least one X-ray fluorescence spectrum of the at least one sample to be measured using the at least one X-ray fluorescence measuring head,
determining the quantitative amount of the at least one print base coat applied to the carrier material in the at least one sample to be measured by comparing the X-ray fluorescence spectrum of the at least one sample to be measured with the calibration model created from the reference samples, and
controlling an application unit of the production line based at least in part upon the comparison of the X-ray fluorescence spectrum of the at least one sample to be measured with the calibration model created from the reference samples to adjust the quantitative amount of the at least one print base coat applied to carrier material in subsequent samples.

20. At least one non-transitory, computer-readable medium, comprising instructions that, when executed by at least one processor, cause the at least one processor to perform the method according to claim 19.
